(19) United States
(12) Patent Application Publication
(10) Pub. No.: US 2014/0027091 A1
(43) Pub. Date: Jan. 30, 2014

(54) Method for Conditioning a Heat/Refrigeration Storage Device, and Vehicle Having a Heat/Refrigeration Storage Device

(71) Applicant: Bayerische Motoren Werke Aktiengesellschaft, Muenchen (DE)

(72) Inventors: Florian SCHNEIDER, Eichenau (DE); Alexander MEIJERING, Muenchen (DE)

(73) Assignee: Bayerische Motoren Werke Aktiengesellschaft, Muenchen (DE)

(21) Appl. No.: 14/041,794

(22) Filed: Sep. 30, 2013

Related U.S. Application Data
(63) Continuation of application No. PCT/EP2012/054413, filed on Mar. 14, 2012.

(30) Foreign Application Priority Data
May 5, 2011 (DE) 10 2011 075 284.6

(51) Int. Cl. B60H 1/00

(52) U.S. Cl. CPC B60H 1/00428
USPC 165/47

(57) ABSTRACT

A method is provided for conditioning a heat/cold storage device of a vehicle by electric energy, as well as a vehicle configured to perform the method. The heat/cold storage device may be provided for heating and/or cooling a vehicle component or a passenger compartment of the vehicle. The electric energy used for conditioning is generated partially or completely from the kinetic energy of the vehicle by a generator which is provided in the vehicle during braking actions or in the overrun mode of the vehicle.

### CROSS REFERENCE TO RELATED APPLICATIONS

This application is a continuation of PCT International Application No. PCT/EP2012/054413 filed Mar. 14, 2012, which claims priority under 35 U.S.C. §119 from German Patent Application No. DE 10 2011 075 284.6, filed May 5, 2011, the entire disclosures of which are expressly incorporated by reference herein.

### BACKGROUND AND SUMMARY OF THE INVENTION

The present invention relates to a method for use of electrical energy generated partially or completely from the kinetic energy of a vehicle for conditioning a heat/cold storage device provided for heating and/or cooling of the vehicle, and a vehicle having such a heat/cold storage device.

Such a method and/or such a vehicle is and/or are known from German patent document no. DE 10 2010 018 906 A1.

German patent document no. DE 10 2010 018 906 A1 describes an air conditioning system for a passenger compartment of a vehicle with at least one decentralized “air conditioning system” that can be supplied with electric energy. The “air conditioning system” may be, for example, a latent heat storage device. When the vehicle is parked, the latent heat storage device can be “charged” from an external electric power source. The latent heat storage device can be used as a heat storage device and/or as a cold storage device. If it acts as a heat storage device, then it can be heated by an external electric power source.

The object of the present invention is to further develop the above described arrangement and/or a vehicle equipped with such an arrangement, in such a way that the energy efficiency of said arrangement and/or vehicle is further improved.

The starting point of the invention is a vehicle, in particular, an electric vehicle or a hybrid vehicle, comprising a heat/cold storage device that is provided for heating and/or cooling a vehicle component or a passenger compartment of the vehicle. The heat/cold storage device can be provided

either exclusively for heating or
for cooling or
optionally for heating or cooling, as a function of the instantaneous operating state of the vehicle.

The heat storage device may include a heat storage medium, which goes through a phase change (“phase change material”) in the operating temperature range, in which the heat/cold storage device is typically operated in a vehicle. This arrangement has the advantage that a very high amount of heat can be stored in such a medium and can be accessed as required (heat storage device); and/or a very large amount of heat can be absorbed as required (cold storage device).

If the heat/cold storage device is intended to be used as a heat storage device, i.e., as a device from which the heat can be removed as required and which feeds this heat to a vehicle component or the passenger compartment, then the heat/cold storage device has to be “conditioned” accordingly. Conditioning means in this context that the heat/cold storage device must be fed heat by way of a heating device; and this heat can be subsequently retrieved, as desired. Therefore, the heat/cold storage device has to be brought into an energetically high state.

If the heat/cold storage device is intended to be used as a cold storage device, then the heat/cold storage device has to be inversely conditioned. That is, heat has to be removed from the heat/cold storage device, so that it can absorb heat, as required, when a vehicle component or the passenger compartment is to be cooled. Therefore, the heat/cold storage device has to be brought into an energetically low state.

For both types of conditioning, i.e., for both conditioning as a heat storage device and also for conditioning as a cold storage device, energy has to be expended and, in particular, according to the invention, electric energy.

The core of the invention lies in generating the electric energy, which is used for conditioning, at least partially, but preferably completely through regeneration. The electric energy, which is used for conditioning, is generated partially or completely from the kinetic energy of the vehicle by means of a generator, which is provided in the vehicle, during braking actions or in overrun mode of the vehicle.

In the case of a hybrid vehicle the generator may be an electric motor, which is operated as a generator and which is provided to generate the vehicle propulsion in the electric motor-powered mode. In case of a purely electric vehicle, the generator may be the electric drive motor of the vehicle, where this electric drive motor works as a generator in the overrun mode and/or during braking phases. In the case of a conventional vehicle with a drive that is powered solely by an internal combustion engine, the generator may be a so called dynamo.

If the electric energy storage device of the vehicle is to be largely or completely loaded, then the heat/cold storage device could be used as an additional energy storage device. In this case the recuperated electric energy is no longer fed into the electric energy storage device during braking actions or in the overrun mode of the vehicle, but rather is used (as needed, as a heat storage device or as a cold storage device) for charging the thermal storage device.

Working on this basis, the heat/cold storage device according to the invention could be used to cover partially or completely the energy requirement that is necessary for air conditioning the passenger compartment or for controlling the temperature of specific vehicle components (such as a high voltage storage device or power electronics) through the recuperation of the kinetic energy of the vehicle, thus increasing the energy efficiency of the entire vehicle.

According to a further development of the invention, a vehicle, which is equipped with a heat/cold storage device according to the invention, has a power connection, by which it can be connected to an external power grid. Then the heat/cold storage device could be preconditioned with the electric energy from the power grid when the vehicle is parked.

The heat/cold storage device could be charged with electric energy from the power grid as a heat storage device by a heater, which may be, for example, an electric heater, a feature that is of interest especially in the event of cool environmental conditions.

Conversely in the event of warm environmental conditions, i.e. especially in the summer months, the heat/cold storage device could be electrically preconditioned as a cold storage device. For this purpose, the vehicle can be provided with an electrically operable cooling device, in particular, an automotive ventilation system with an electrically operated fan; and/or the vehicle can be provided with an automotive air conditioning system with an electrically operated compressor, by which the heat can be removed from the heat/cold storage device. As an alternative, the heat could also be removed from the heat/cold storage device with a cooling device of a different type, for example, on the basis of Peltier elements; and the heat/cold storage device could be preconditioned in this way as a cold storage device.

In order to condition the heat/cold storage device, it is possible to provide a heat exchanger through which the air flows. The heat/cold storage device can be arranged downstream of the heat exchanger in the flow direction of the air in such a way that the air coming from the heat exchanger flows through or around the heat/cold storage device.

Depending on the operating state, the heat exchanger can be formed by, for example, a thermal heat exchanger or by an evaporator of the air conditioning system of the vehicle. In an operating state, in which the heat/cold storage device is intended to be used for heating, i.e. is conditioned as a heat storage device, the heat/cold storage device can be thermally charged by a thermal heat exchanger of the air conditioning system of the vehicle. In an operating state, in which the heat/cold storage device is intended to be used for cooling, i.e. is conditioned as a cold storage device, the heat can be removed from the heat/cold storage device by an evaporator of air conditioning system of the vehicle.

In order to condition the heat/cold storage device as a cold storage device, the heat/cold storage device can be coupled, for example thermally, with a refrigerant circuit of the air conditioning system of the vehicle; and the refrigerant of the refrigerant circuit can flow through or around the heat/cold storage device; or the heat/cold storage device can be thermally coupled with a component of the refrigerant circuit, where the refrigerant flows through said component.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a schematic illustration of an embodiment of the present invention, wherein the heat/cold storage device is conditioned as a heat storage device, and

FIG. 2 is a schematic illustration of an embodiment of the present invention, wherein the cold/heat storage device is conditioned as a cold storage device.

### DETAILED DESCRIPTION OF THE DRAWINGS

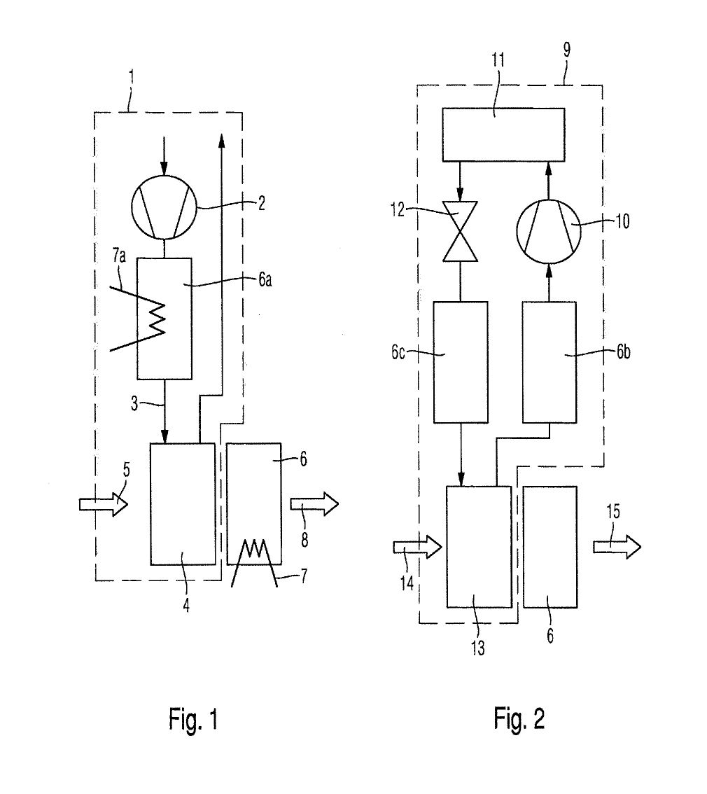

FIG. 1 shows a section 1 of a heating circuit of an automotive air conditioning system, which is not shown in greater detail herein. The heating circuit has a coolant pump 2 and a thermal heat exchanger 4, which is connected to said coolant pump by a coolant line 3. This thermal heat exchanger is arranged downstream of the coolant pump 2 in the flow direction of the coolant. To this end the coolant pump 2 is provided to pump coolant through the components of a vehicle that are to be cooled, for example, through the cooling system of an internal combustion engine. Heat absorbed by the coolant can be dissipated via a cooling device into the surrounding area or through the thermal heat exchanger into the air that is conveyed to a passenger compartment of the vehicle. The thermal heat exchanger 4 is traversed by the air 5 that is to be heated.

A heat/cold storage device 6 is arranged downstream of the thermal heat exchanger 4, when viewed in the flow direction of the air 5 that is to be heated. In the “heating case” shown in FIG. 1, the heat/cold storage device 6 is designed to act as a heat storage device. Correspondingly said heat/cold storage device is and/or will be thermally charged, i.e. brought up to an energetically high level. In order to charge the heat/cold storage device as a heat storage device, there is an electric heater 7, which is operated preferably with the electric energy that is recuperated during the braking phases and/or during the overrun phases of the vehicle. As an alternative or in addition, the heat/cold storage device 6 could also be thermally charged by warm air that has been heated by the thermal heat exchanger 4.

Such a heat storage device is advantageous, in particular during cold starts in the winter, i.e., when the coolant flowing in the coolant circuit is still cold, and the heat is not yet available. However, a heat storage device, which is suitably preconditioned by the heater 7, can provide heat with almost zero delay, i.e. can provide heat as early as immediately after a cold start of the vehicle. Then the heated air 8 can be conveyed to a passenger compartment or to a vehicle component that is to be heated, such as a high voltage storage device or any other electronic components.

As an alternative to the arrangement of the heat storage device shown in FIG. 1 and labeled with the reference numeral 6, said heat storage device can also be arranged in the coolant circuit, an arrangement that is indicated by the reference numerals 6a, 7a. If the heat storage device 6a is arranged in the “coolant circuit” of the vehicle, it can be traversed by the coolant; and/or the coolant can flow around the heat storage device; or the heat storage device can be thermally connected to a component of the coolant circuit. In this case the heat storage device is used to bring the coolant more quickly up to an operating temperature during a cold start of the vehicle, i.e., when the coolant is still cold.

FIG. 2 shows the application of a heat/cold storage device that is used as a cold storage device. In this operating state the cold storage device interacts with an air conditioning system 9 of the vehicle. The automotive air conditioning system comprises, when viewed in the flow direction, a refrigerant compressor 10 (preferably electrically operated). This refrigerant compressor compresses the refrigerant and pumps the refrigerant through a condenser 11. Downstream of the condenser 11 there is an expansion element 12, by means of which the compressed refrigerant is expanded. Coming from the expansion element 12, the refrigerant flows through an evaporator 13. From the evaporator, the refrigerant flows back to the intake side of the refrigerant compressor 10. The air 14, which is to be cooled and which is to be conveyed, for example, to a passenger compartment or to a vehicle component that is to be cooled, flows through the evaporator 13. Then the cooled air 15 can be conveyed to the passenger compartment or to the vehicle component that is to be cooled. The heat/cold storage device 6, which acts here as a cold storage device, can be arranged downstream of the evaporator 13, when viewed in the flow direction of the air 14 that is to be cooled. Then the heat can be removed from the heat/cold storage device 6 by means of the air that has been cooled by means of the evaporator 13; and, thus, this heat/cold storage device can be conditioned as a cold storage device.

As an alternative to the “air sided” arrangement (labeled with the reference numeral 6) of this heat/cold storage device, this heat/cold storage device can be arranged in the refrigerant circuit. For example, it can be provided that the heat/cold storage device is arranged between the evaporator 13 and the intake side of the refrigerant compressor 10, an arrangement that is indicated by the reference numeral 6b. As an alternative, it could also be provided that the heat/cold storage device is arranged between the expansion element 12 and the evaporator 13, an arrangement that is indicated by the reference numeral 6c. In both cases the heat/cold storage device can be traversed by the refrigerant; or the refrigerant can flow around the heat/cold storage device; or the heat/cold storage device can be thermally coupled with a component of the air conditioning system 9 of the vehicle.

Of course, it can be provided that the heat/cold storage device can be switched over between one of the states shown in FIG. 1, wherein it is charged as a heat storage device and/or acts as a heat storage device, and one of the states shown in FIG. 2, wherein it is charged as a cold storage device and/or acts as a cold storage device. A switch-over of the associated valves (not shown) is possible in a simple manner, if the heat/cold storage device is integrated into the heating circuit and/or into the refrigerant circuit, i.e., is traversed by the coolant in one operating state and is traversed by the refrigerant in the other operating state.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for conditioning a heat/cold storage device of a vehicle provided for heating and/or cooling a vehicle component or a passenger compartment of the vehicle, comprising the acts of:
generating electric energy at least one of partially and completely from a kinetic energy of the vehicle using a generator; and
providing the electric energy to the heat/cold storage device of the vehicle,
wherein the kinetic energy is converted by the generator to generate the electric energy during at least one of braking actions and an overrun mode of the vehicle.

2. A vehicle, comprising:
a heat/cold storage device, the heat/cold storage device being configured to provide at least one of heating and cooling to at least one of a vehicle component and a passenger compartment of the vehicle; and
a generator,
wherein
the generator is configured to convert kinetic energy of the vehicle into electric energy and to provide the electric energy to the heat/cold storage device of the vehicle, and
the kinetic energy of the vehicle is converted by the generator to generate the electric energy during at least one of braking actions and an overrun mode of the vehicle.

3. The method as claimed in claim 1, wherein the vehicle comprises a power connection for connecting to a stationary power grid, and the heat/cold storage device can be preconditioned with electric energy from the power grid when the vehicle is parked.

4. The vehicle as claimed in claim 2, wherein the vehicle comprises a power connection for connecting to a stationary power grid, and the heat/cold storage device can be preconditioned with electric energy from the power grid when the vehicle is parked.

5. The method as claimed in claim 1, further comprising the act of:
feeding heat from an electric heater to the heat/cold storage device.

6. The method as claimed in claim 3, further comprising the act of:
feeding heat from an electric heater to the heat/cold storage device.

7. The vehicle as claimed in claim 2, further comprising:
an electric heater configured to feed heat to the heat/cold storage device.

8. The vehicle as claimed in claim 4, further comprising:
an electric heater configured to feed heat to the heat/cold storage device.

9. The method as claimed in claim 1, further comprising the act of:
removing heat from the heat/cold storage device with at least one of an automotive ventilation system with an electrically operated fan and an automotive air conditioning system with an electrically operated compressor.

10. The vehicle as claimed in claim 1, further comprising:
at least one of an automotive ventilation system with an electrically operated fan and an automotive air conditioning system with an electrically operated compressor configured to remove heat from the heat/cold storage device.

11. The method as claimed in claim 1, further comprising the act of:
flowing air through a heat exchanger arranged upstream in an air flow direction of the heat/cold storage device such that the air flowing through the heat exchanger flows at least one of through and around the heat/cold storage device.

12. The vehicle as claimed in claim 1, further comprising:
a heat exchanger, the heat exchanger being arranged upstream in an air flow direction from the heat/cold storage device and configured such that air flow through the heat exchanger flows at least one of through and around the heat/cold storage device.

13. The method as claimed in claim 11, wherein
when the vehicle is in an operating state in which the heat/cold storage device is used for heating, the heat exchanger is a thermal heat exchanger of a heating or coolant circuit of the vehicle, and
when the vehicle in an operating state in which the heat/cold storage device is used for cooling, the heat exchanger is an evaporator of the automotive air conditioning system.

14. The vehicle as claimed in claim 12, wherein
when the vehicle is in an operating state in which the heat/cold storage device is used for heating, the heat exchanger is a thermal heat exchanger of a heating or coolant circuit of the vehicle, and
when the vehicle in an operating state in which the heat/cold storage device is used for cooling, the heat exchanger is an evaporator of the automotive air conditioning system.

15. The method as claimed in claim 13, wherein depending on the operating state,
the heat/cold storage device is thermally coupled with a heating circuit or with a refrigerant circuit of the air conditioning system of the vehicle and the coolant and/or the refrigerant of the refrigerant circuit flows at least one of through and around the heat/cold storage device; and/or
the heat/cold storage device is coupled in a thermally conductive manner with a component of the heating circuit and/or the coolant circuit, wherein the coolant or the refrigerant flows through said component.

16. The vehicle as claimed in claim 14, wherein depending on the operating state,
the heat/cold storage device is thermally coupled with a heating circuit or with a refrigerant circuit of the air conditioning system of the vehicle and the coolant and/or the refrigerant of the refrigerant circuit flows at least one of through and around the heat/cold storage device; and/or
the heat/cold storage device is coupled in a thermally conductive manner with a component of the heating circuit and/or the coolant circuit, wherein the coolant or the refrigerant flows through said component.

17. The method as claimed in claim 1, wherein the heat/cold storage device comprises a substance that goes through a phase change at a temperature within a predetermined operating temperature range.

18. The vehicle as claimed in claim 1, wherein the heat/cold storage device comprises a substance that goes through a phase change at a temperature within a predetermined operating temperature range.
